(19) United States
(12) Patent Application Publication
(10) Pub. No.: US 2007/0211307 A1
(43) Pub. Date: Sep. 13, 2007

(54) IMAGE PROCESSING APPARATUS AND METHOD FOR REDUCING NOISE IN IMAGE SIGNAL

(75) Inventor: Timofei Uvarov, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd., Suwon-si (KR)

(21) Appl. No.: 11/679,671

(22) Filed: Feb. 27, 2007

(30) Foreign Application Priority Data
Feb. 28, 2006 (KR) 10-2006-0019584

(51) Int. Cl. G06F 15/00

(52) U.S. Cl. 358/463; 358/1.9

(57) ABSTRACT

An image signal processing apparatus to remove noise included in an image signal includes a GR-GB correction unit, a threshold calculation unit, and a preprocessing and interpolation unit. The GR-GB correction unit detects a first area in response to the difference between a correction threshold and the absolute value of the difference between a current pixel of the image signal and neighboring pixels having the same color as that of the current pixel, and filters noise included in the first area. The threshold calculation unit calculates an edge threshold and a similarity threshold in response to a signal level of each pixel of the image signal, and an analog gain control (AGC) value. The preprocessing and interpolation unit compares an edge identifier calculated in response to spatial deviation at each pixel of the image signal with the edge threshold, determines whether the pixel is an edge area or a flat area, and in response to the result of the determination, generates an interpolated RGB image signal.

### CR0SS-REFERENCE TO RELATED PATENT APPLICATIONS

This application claims priority to Korean Patent Application No. 10-2006-0019584 filed on Feb. 28 2006, in the Korean intellectual Property Office, the disclosure of which is incorporated by reference herein in its entirety.

### BACKGR0UND OF THE INVENTION

1. Technical Field

The present disclosure relates to image signal processing , and more particularly, to an image signal processing apparatus and a method of removing noise from an image signal.

2. Discussion of the Related Art

An image sensing system such as a digital still camera (DSC):, includes an image-sensing device in the form of an active pixel sensor (APS) array. Most image-sensing devices generate image signals having three colors, green (G), blue (B), and red (R): in a Bayer pattern illustrated in FIG. 1.

When a Bayer color filter array (CFA) structure is applied to an image-sensing device, a CMOS image sensor (CIS) for each pixel generates an image signal corresponding to one color of G, B, and R.

Since the image signal has an electrical characteristic, the performance of an entire camera system can be degraded due to noise caused by the electrical characteristic of the generated image signal,

A method of spatial low-pass filtering (or blurring) may be used to remove the noise from an image signal. The spatial low-pass filtering method can obtain a high signal-to-noise ratio (SNR), but causes loss of detail in an image generated from the image signal.

A method of low-pass filtering only an area that does not include meaningful spatial information may also be used to remove noise, However with this method high frequency components of an image may be distorted.

### SUMMARY OF THE INVENTION

According to an exemplary embodiment of the present invention there is provided an image signal processing apparatus to remove noise included in an image signal. The apparatus includes a GR-GB correction unit a threshold calculation unit, and a preprocessing and interpolation unit. The GR-GB correction unit detects a first area in response to the difference between a correction threshold and the absolute value of the difference between a current pixel of the image signal and neighboring pixels having the same color as that of the current pixel and filters noise included in the first area. The threshold calculation unit calculates an edge threshold and a similarity threshold in response to a signal level of each pixel of the image signal and an analog gain control (AGC) value. The preprocessing and interpolation unit compares an edge identifier calculated in response to the spatial deviation at each pixel of the image signal, with the edge threshold, determines whether the pixel is an edge area or a flat area, and in response to the result of the determination, generates an interpolated RGB image signal.

The GR-GB correction unit may filter noise by using sigma filtering. The edge threshold may be a sum of a corrected level in proportion to the signal level of each of the pixels and an analog gain control (AGC) threshold in proportion to the AGC value. The similarity threshold may be calculated in proportion to the signal level of each pixel that is currently being processed.

The preprocessing and interpolation unit may include an edge detection unit, a second interpolation unit, a filtering unit and a first interpolation unit. The edge detection unit may compare the edge identifier calculated in response to the spatial deviation at each pixel of the image signal with the edge threshold to determine whether the pixel is an edge area or a flat area. The filtering unit, may filter noise included in the flat area by using a predetermined filtering method to generate filtered pixels. The first interpolation unit may interpolate the filtered pixels. The second interpolation unit may interpolate pixels determined to be an edge area by using a predetermined interpolation method.

The filtering unit may filter noise by using sigma filtering. The first interpolation unit may perform interpolation by using median filtering. The second interpolation unit may perform interpolation using directional interpolation. The image signal may be an image signal of a Bayer pattern.

The apparatus may further include an image data transform unit and a post-processing unit. The image data transform unit may transform the RGB image signal interpolated by the preprocessing and interpolation unit into a YCrCb image signal. The post-processing unit may interpolate a Y signal in the transformed YCrCb image signal. The post-processing unit may interpolate the Y signal by using sigma filtering.

According to an exemplary embodiment of the present invention, there is provided an image signal processing method for removing noise included in an image signal. The method includes the steps of detecting a first area in response to the difference between a correction threshold and the absolute value of the difference between a current pixel of the image signal and neighboring pixels having the same color as that of the current pixel, and filtering noise included in the first area; calculating an edge threshold and a similarity threshold in response to a signal level of each pixel of the image signal, and an analog gain control (AGC) value; and comparing an edge identifier calculated in response to spatial deviation at each pixel of the image signal with the edge threshold determining whether the pixel is an edge area or a flat area, and in response to the result of the determination, interpolating each pixel of the image signal to generate an interpolated RGB image signal.

The calculating of the edge threshold may include: calculating a corrected level in proportion to the signal level of each of the pixels; calculating an AGC threshold in proportion to the AGC value; and adding the corrected level to the AGC threshold.

The interpolating of each pixel of the image signal may include: comparing the edge identifier calculated in response to the spatial deviation at each pixel of the image signal with the edge threshold to determine whether the pixel is an edge area or a flat area; interpolating pixels determined to be an edge area by using a predetermined interpolation method, and filtering noise included in the flat area by using a predetermined filtering method to generate filtered pixels and interpolating the filtered pixels. The image signal may be an image signal of a Bayer pattern.

The method may further include: transforming the interpolated RGB image signal into a YCrCb image signal, and interpolating a Y signal in the transformed YCrCb image signal.

### BRIEF DESCRIPTION OF THE DRAWINGS

The above and other features of the present invention will become more apparent by describing in detail exemplary embodiments thereof with reference to the attached drawings in which:

FIG. 1 illustrates a Bayer pattern pixel array;

FIG. 2 is a block diagram of an image signal processing apparatus according to an exemplary embodiment of the present invention;

FIG. 3 is a diagram to explain an operation of a GR-GB correction unit of FIG. 2 according to an exemplary embodiment of the present invention;

FIG. 4 is a block diagram of a sigma preprocessing and interpolation unit of FIG. 2 according to an exemplary embodiment of the present invention;

FIG. 5 is a diagram to explain an operation of calculating an edge identifier according to an exemplary embodiment of the present invention;

FIG. 6 illustrates relations among an analog gain control (AGC) value, an AGC threshold value, and a signal level in an edge detection operation according to an exemplary embodiment of the present invention;

FIG. 7 illustrates relations among a signal level, a threshold, and a weight in a sigma preprocessing operation according to an exemplary embodiment of the present invention,

FIG. 8 is a diagram to explain an interpolation operation at a flat area according to an exemplary embodiment of the present invention; and

FIG. 9 is a flowchart illustrating an image signal processing method according to an exemplary embodiment of the present invention.

### DETAILED DESCRIPTION OF EXEMPLARY EMBODIMENTS

Hereinafter, exemplary embodiments of the present invention will be described in detail with reference to the attached drawings.

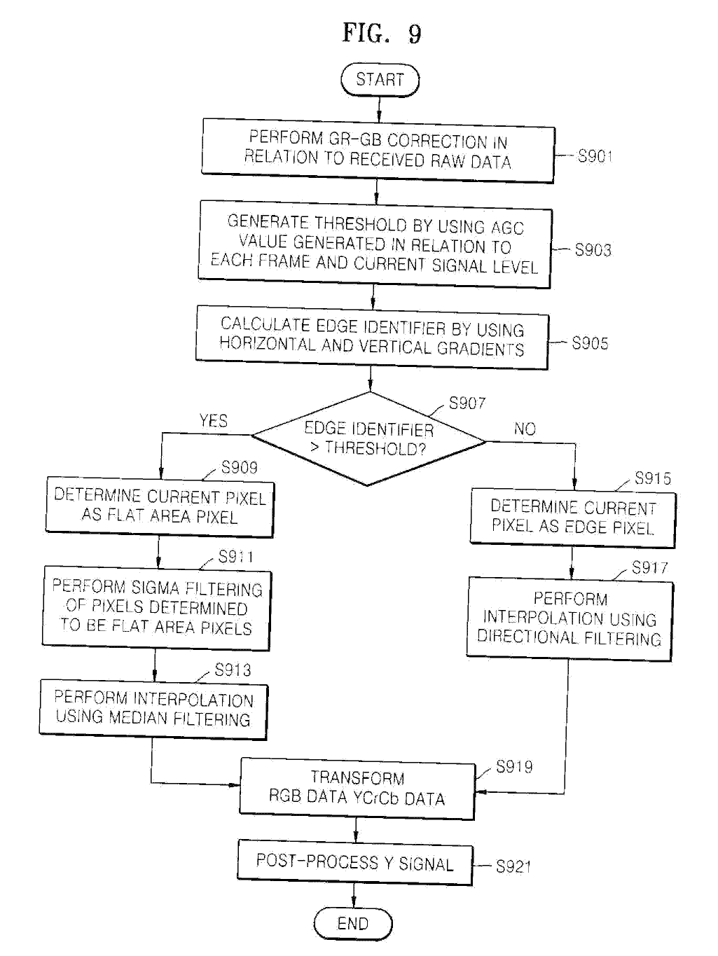

FIG. 2 is a block diagram of an image signal processing apparatus according to an exemplary embodiment of the present invention, and FIG. 9 is a flowchart illustrating an image signal processing method according to an exemplary embodiment of the present invention. The image signal processing apparatus 200 includes a GR-GB correction unit 210. a threshold calculation unit 230, a preprocessing and interpolation unit 250, an image data transform unit 270, and a post-processing unit 290.

The GR-GB correction unit 210 filters noise from input image data RAW_DATA. The GR-GB correction unit 210 performs GR-GB correction on the image data RAW_DATA by quickly and roughly filtering noise in a first area (i.e., noise in a very flat area or a very smooth area) of an image of the image data RAW DATA in an operation S901. The input image data RAW-DATA may be raw data from an image-sensing device. The image-sensing device may be a charge coupled device (CCD).

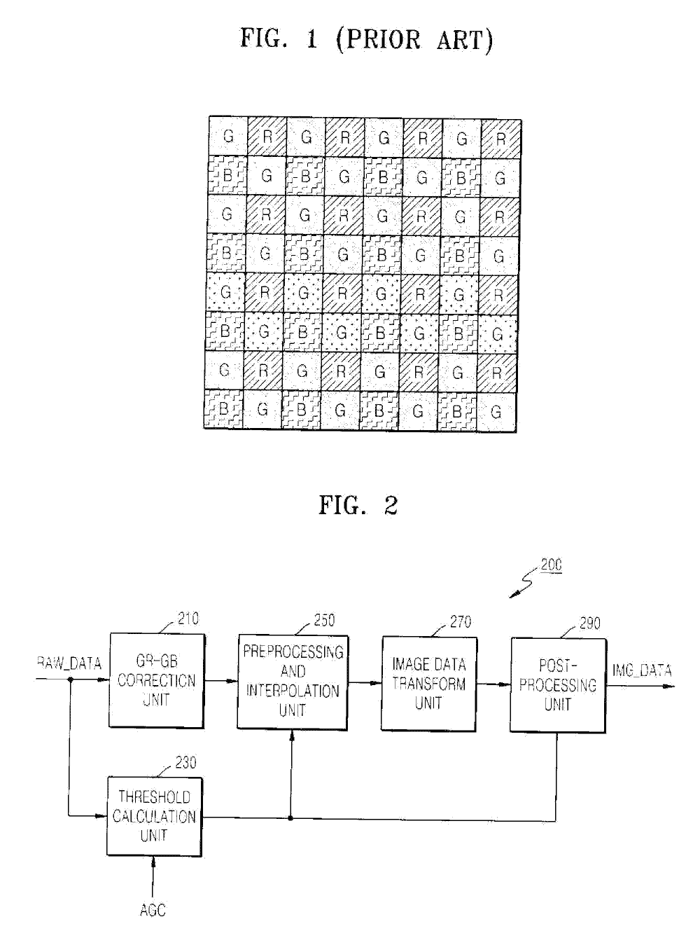

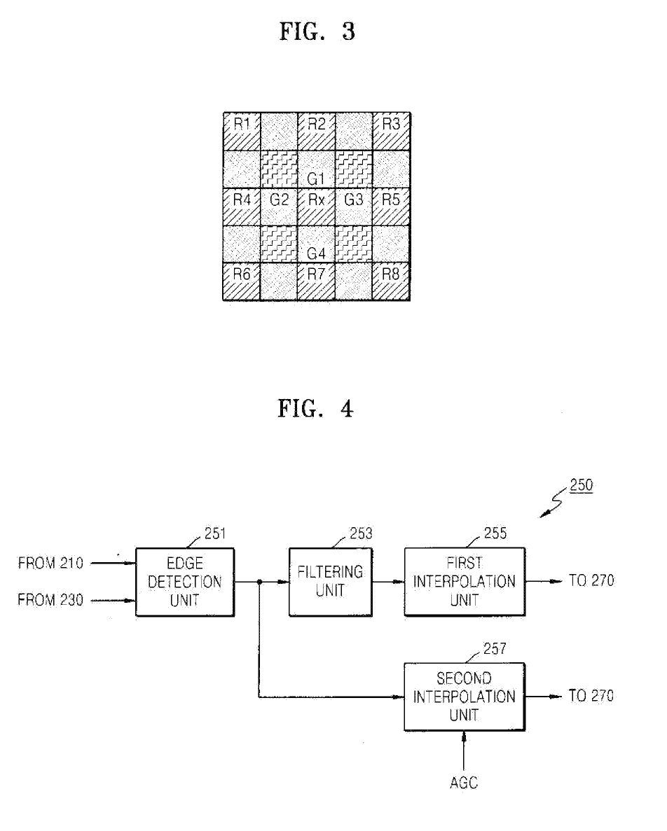

FIG. 3 is a diagram to explain an operation of the GR-GB correction unit 210 of FIG. 2 according to an exemplary embodiment of the present invention, and may be part of the Bayer pattern of FIG. 1. By using the following equation 1. the GR-GB correction unit 210 detects whether or not a current pixel RX currently being processed in the image is a first area:
\RX−R[i]\<TH_{—}GRGB, i=1, 3, 6, 8 (1)
where R[i] are neighboring pixels having the same color as that of the current pixel RX. and TH_GRGB is a predetermined correction threshold determined by considering the characteristics of a CCD, and the environment when the image is taken, regardless of a signal level. The correction threshold to detect a first area in a given image-sensing environment can be determined by conventional methods.

If the current pixel RX is a first area, noise included in the current pixel RX is removed quickly and roughly by using the following equation 2,
RX=R[i]×W[i]+RX×WX (2)
where H[i] is a predetermined correction weight in relation to a neighboring pixel R[i], and WX is a predetermined correction weight in relation to the current pixel RX. A correction weight may be determined by considering the characteristics of a CCD, and the environment when the image is taken, regardless of a signal level. The correction weight in a given image-sensing environment can be determined by conventional methods.

Although corrections were discussed with respect to red pixels above, substantially identical corrections may be performed on green and blue pixels. In a G channel, a difference between the values of red or blue pixels can occur, and therefore a different correction threshold may also be used.

The threshold calculation unit 230 calculates thresholds to be used in the preprocessing and interpolation unit 250 and the post-processing unit 290, in response to an analog gain control (AGC) value. The AGC value may be generated by an image-sensing system (not shown) having an image signal processing apparatus according to an exemplary embodiment of the present invention, and the pixel value of a pixel being processed (i.e., a signal level) in an operation S903.

The preprocessing and interpolation unit 250 performs precise and accurate removal of additional noise of the image data in which noise in the first area was removed by the GR-GB correction unit 210. The preprocessing and interpolation unit 250 detects whether each pixel of the image data is an edge area or a flat area and according to the result, performs interpolation thereby removing noise included in the image data.

FIG. 4 is a block diagram of the preprocessing and interpolation unit 250 of FIG. 2 according to an exemplary embodiment of the present invention. The preprocessing and interpolation unit 250 is composed of an edge detection unit 251, a filtering unit 253. a first interpolation unit 255, and a second interpolation unit 257. The edge detection unit 251 compares an edge threshold with an edge identifier (TH_EDGE). The edge threshold is calculated in the threshold calculation unit 230 by using the signal level of the image data and the AGC value. The edge identifier (EDGE_ID) is calculated by using a gradient of an image signal to determine whether a current pixel is an edge area or a flat area.

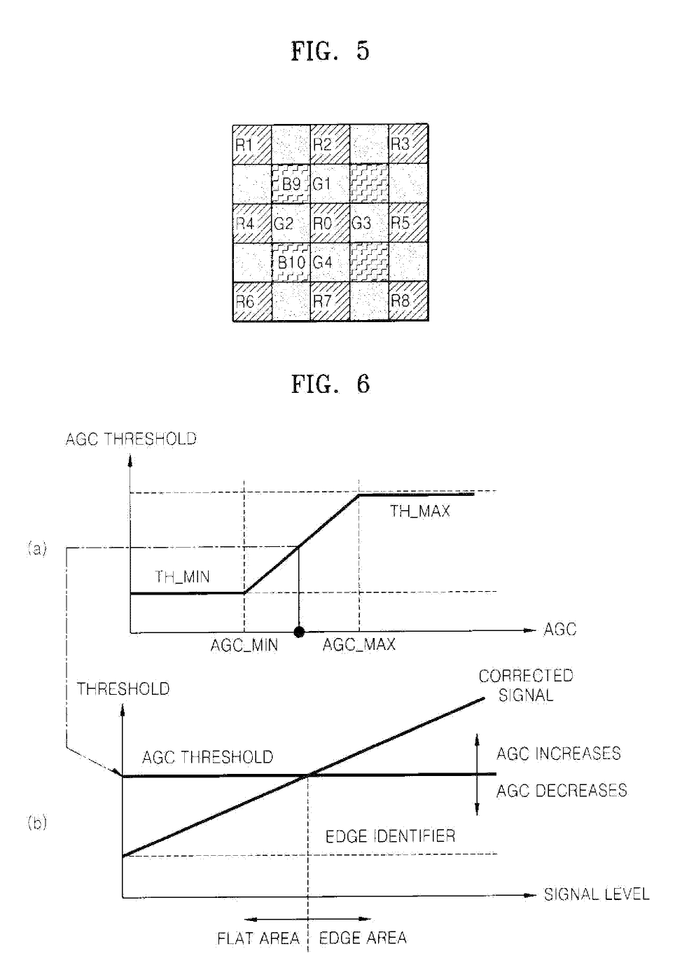

FIG. 5 is a diagram to explain an operation of calculating an edge identifier according to an exemplary embodiment of the present invention. The edge detection unit 251 calculates an edge identifier (EDGE_ID) by calculating a series of deviations, e.g. gradients, in a spatial area of the image data. FIG. 5 shows a 3×3 window in relation to an R channel. In at least one embodiment of the present invention, an edge identifier (EDGE_ID) is calculated by using the deviation in the 3×3 window, and an edge identifier (EDGE_ID) is calculated in relation to all pixels of the image data in an operation S905.

Each deviation is a sum of absolute values of differences between a current pixel and neighboring pixels having the same color as that of the current pixel. For example, the deviation at a current pixel R0 may have a vertical deviation (D_VER) and a horizontal deviation (D_HOR) calculated by the following equations 3 and 4 respectively:
D_{—}HOR=\G2−G3\+\R4−R0\+\R5−R0\ (3)
D_{—}VER=\G1−G4\+\R2−R0\+\R7−R0\ (4)

Referring to FIG. 5. the horizontal deviation (D_HOR) and the vertical deviation (D_VER) at the current pixel R0 are calculated by using 5 pixels with the current pixel at the center in the horizontal direction and in the vertical direction, respectively, as illustrated in the equations 3 and 4.

In an exemplary embodiment of the present invention, an edge identifier (EDGE_ID) is calculated by using the following equation 5:
EDGE_ID=MAX[i=1˜5](D_{—}HOR(i))+MAX[i=1˜5](D_{—}VER(i)) (5)

As illustrated in the equation 5, the edge identifier (EDGE_ID) is set to the sum of maximum values of the deviations,

The edge detection unit 251 compares the calculated edge identifier (EDGE_ID) with an edge threshold (TH_EDGE) and detects whether the current pixel is an edge area or a flat area.

An edge area and a flat area can be distinguished by comparison of the deviations described above with a predetermined threshold indicating a flat area, The predetermined threshold indicating a flat area can be predicted and since this threshold relies on noise in a flat area, noise in a flat area may be measured.

In at least one embodiment of the present invention, it is assumed that a noise deviation relies on a current signal level and an applied AGC value, and the noise deviation increases as the signal level increases. In most image-sensing devices an AGC value is automatically gain-controlled based on an image-sensing environment and illuminance. A noise deviation measured at arbitrary levels has non-linear characteristics, but can be made linear according to at least one embodiment of the present invention. Accordingly, a thus corrected value is not applied in an SNR area but in an absolute value area.

An edge threshold (TH_EDGE) may be determined by first calculating a corrected level (LEVEL_COR) using the following equation 6:
LEVEL_COR=C1+M×CPV(x, y) (6)
where C1 is a value determined with respect to an AGC value, M is a value determined with respect to illuminance, and CPV(X, y) is a signal value of a current pixel. The corrected level (LEVEL_COR) is calculated with respect to each pixel, and can be calculated such that the corrected level (LEVEL_COR) relies on color information for performance enhancement, or can be calculated by using neighboring pixels of a current pixel.

The AGC value is determined by an auto exposure method, and relies on illuminance in an image-sensing environment.

A fixed AGC threshold (TH_AGC) can be measured by dividing a range between a maximum AGC value (AGC_MAX) and a minimum AGC value (AGC_MIN) into predetermined intervals. Since an AGC operation typically uses multiplication. the AGC operation amplifies not only a signal level. but also the noise level. If a maximum AGC value (AGC_MAX) and a minimum AGC value (AGC_MIN) are known, fixed thresholds may be determined. Accordingly an AGC threshold reflecting an AGC value can be calculated by using an approximated linear calculation as in the following equation 7:
TH_AGC=C2+(AGC−AGC_MIN)×M2 (7)
where C2 and M2 are values determined by an image-sensing environment and illuminance, and AGC is a current AGC value, and AGC_MIN is a minimum AGC value. Here the AGC threshold (TH_AGC) is calculated with respect to each frame, not to each pixel.

An edge threshold is the sum of a corrected level (LEVEL_COR) and an AGC threshold (TH_AGC) as in the following equation 8:
TH_EDGE=LEVEL_COR+TH_{—}AGC (8)

The edge detection unit 251 compares the calculated edge identifier (EDGE_ID) with the edge threshold (TH_EDGE) in an operation S907 and determines whether a current pixel is an edge area or a flat area. if the edge threshold (TH_EDGE) is greater than the edge identifier (EDGE_ID), the current pixel is determined to be a pixel of an edge area in an operation S915, and if the edge threshold (TH_EDGE) is not greater than the edge identifier (EDGE_ID), the current pixel is determined to be a pixel of a flat area in an operation S909.

FIG. 6 illustrates relations among an analog gain control (AGC) value, an AGC threshold values and a signal level in an edge detection operation according to an exemplary embodiment of the present invention. As illustrated in FIG. 6A, according to the graph of a linearized AGC value and an AGC threshold, an AGC threshold with respect to an arbitrary AGC value in each frame is determined, As illustrated in FIG. 6B, if a corrected signal (SIGNAL_COR) reflecting an edge identifier (EDGE_ID) is less than an AGC threshold (TH_AGC), the current pixel is determined to be a flat area, and if the corrected signal (SIGNAL_COR) reflecting the edge identifier (EDGE_ID) is not less than an AGC threshold (TH_AGC), the current pixel is determined to be an edge area.

Since only one frame is processed, an illuminance condition and adaptation in relation to an AGC change only an AGC threshold (TH_AGC). As illustrated in FIG. 6B as the AGC threshold (TH_AGC) increases, it becomes more likely that the current pixel will be determined to be a flat area. Alternately, as the AGC threshold (TH_AGC) decreases, it becomes more likely that the current pixel will be determined to be an edge area. Accordingly, more noise can be removed.

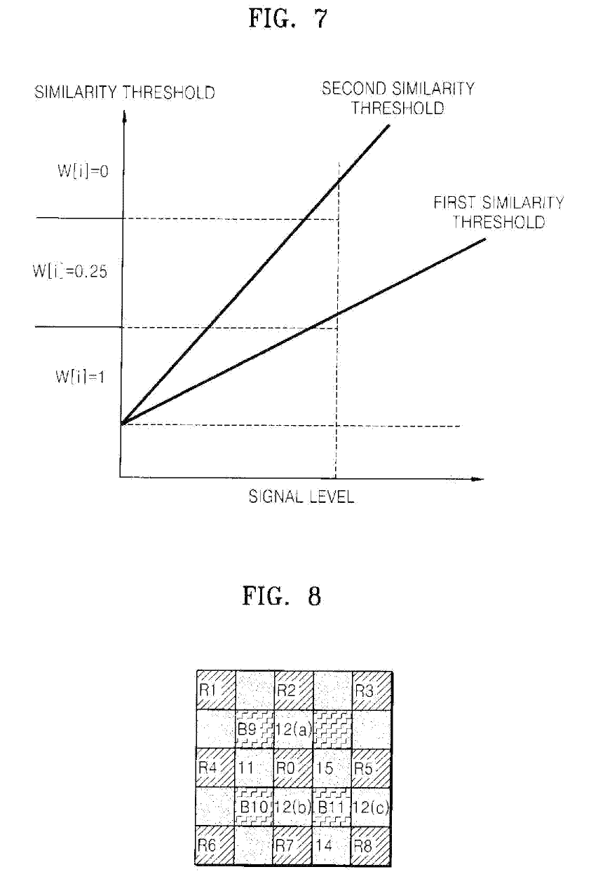

Referring again to FIG. 4, the edge detection unit 251 detects whether the current pixel is an edge area or a flat area, and according to the detection result, each pixel of the image data is processed in a different way, A pixel determined to be a flat area goes through a duplicate noise removal process. Alternately, a pixel determined to be an edge area goes through an ordinary noise removal process by the second interpolation unit 257. An operation of removing noise included in the image data will now be explained with reference to FIGS. 7 and 8.

First, if the edge detection unit 251 determines a pixel to be a flat area, the pixel is transmitted to the filtering unit 253. The filtering unit performs a predetermined filtering to remove noise included in the flat area, In at least one embodiment of the present invention, the filtering unit 253 performs sigma filtering in an operation S911.

Sigma filtering is a simple low-pass filtering which is performed by obtaining a mean of values of pixels having values close to the value of a current pixel among pixels adjacent to the current pixel. Accordingly, the filtered result is a weighted sum of neighboring pixels, and the weight of each pixel is determined according to the current pixel value and similarity.

Pixels to be used to obtain a mean are selected by comparing the difference between the value of a pixel with the current pixel value, with a predetermined similarity threshold (TH_SIG). A process of selecting pixels to be used to obtain a mean will now be explained with reference to the following equations 9 through 14 and FIG. 5:
RX=SUM/SUMW (9)
SUW=RX+R[1]*W[1]+ . . . +R[8]*W[8] (10)
SumW=1+W[1]+ . . . +W[8] (11)
W[i]=1 if \RX−R[i]\<TH_{—}SIG1(x,y) (12-1)
W[i]=0.25 if \RX−R[i]\<TH_{—}SIG2(x,y) (12-2)
W[i]=0 if \RX−R[i]>TH_{—}SIG2(x,y) (12-3)
TH_{—}SIG1(x,y)=M1×SIG(x,y)+C1 (13)
TH_{—}SIG1(x,y)=M2×SIC(x,y)+C2 (14)
where RX is a result of performing sigma filtering, W[i] is a weight value for an i-th pixel. TH_SIG1(x, y) and TH_SIG2(x, y) are a first similarity threshold and a second similarity threshold, respectively, at pixel (x, y), and SIG(x, y) is the pixel value of pixel (x, y). The weight value of a current pixel, i.e.>a center pixel (R0), is 1.

The first and second similarity thresholds (TH_SIG1, and TH_SIG2) are values that increase with respect to a signal level, and are calculated in relation to each pixel to be processed. FIG. 7 Illustrates relations among a signal level, a threshold, and a weight in a sigma preprocessing operation according to an exemplary embodiment of the present invention. Considering that a noise deviation increases with the increasing signal level and it can be difficult to find noise in a dark area, the similarity threshold (TH_SIG) is also expected to increase as signal level increases. Accordingly, the first and second similarity thresholds (TH_SIG1 and TH_SIG2) are determined in a manner similar to that of determining the edge threshold described above.

FIG. 7 illustrates the relation between a similarity threshold and a weight value with respect to a signal level. As illustrated in FIG. 7, the similarity threshold (TH_SIG1 or TH_SIG2) is in proportion to a signal level. The first and second similarity thresholds (TH_SIG1 and TH_SIG2) can be determined by using the graph of FIG. 7.

In relation to the pixels determined to be a flat area filtering by the filtering unit 253 is performed and then interpolation by the first interpolation unit 255 is additionally performed. The first interpolation unit 255 performs interpolation of 2 lost color components in relation to the image data in which noise is removed by the filtering unit, by using a predetermined interpolation method in an operation S913. The predetermined interpolation method may be a median filtering method.

Typically, in median filtering, the median value of five values is the center value (i.e., third value) when the five values are sorted. The median value of four values is the mean of the second and third values when the four values are sorted.

Referring to FIG. 5, G pixel value (G0) at an R/B position is calculated by using the following equation 15;
G0=Median(G1, G2, G3, G4) (15)
Where Median( ) is a median value. Similarly, B pixel value (B2) and R pixel value (R2) at a G position are calculated by using the following equations 16 and
B2=(B9+B10)/2 (16)
R2=(R4+R0)/2 (17)

The second interpolation unit 257 performs interpolation in relation to pixels determined to be an edge area by using an ordinary interpolation method. The interpolation method may be a directional interpolation method. The second interpolation unit may perform directional interpolation in a color differential space in an operation S917, In directional interpolation., removal of noise is typically not performed because in a high frequency area such as an edge area, resolution is more important than noise.

Referring again to FIG. 4, after different interpolations are performed in relation to pixels in the image data according to whether or not a pixel being currently processed in image data is an edge area, the image data is output as RGB data. The image data transform unit 270 transforms the RGB data into YCrCb data to store and display an image in an operation 5919.

As described above, noise in the first area of the image data is removed by the GR-GB correction unit 410, and noise and defects in a flat area are filtered by the filtering unit 253 and the first interpolation unit 255. Since human eyes are generally more sensitive to an illuminance change than a color change, interpolation is performed in relation to the illuminance (Y) component of the image data once more. therein without departing from the spirit and scope of the present invention as defined by the following claims.

The post-processing unit 290 performs interpolation of the illuminance (Y) component once more among YCrCb components transformed by the image data transform unit 270, by using a predetermined filtering method in an operation S921. The predetermined filtering method may be a sigma filtering method. The sigma filtering method is performed in a manner similar to that of the sigma filtering method performed in the filtering unit 253.

As described above, the image signal processing apparatus according to at least one embodiment of the present invention removes noise included in the input image data in 3 steps, First, the GR-GB correction unit 210 corrects a GR-GR difference by removing noise in a flat area, i.e., a dark area, having a low noise deviations Next, the preprocessing and interpolation unit 250 removes noise and defects in a flat area, i.e., a bright area, having a high noise deviation, and by doing so, removes noise in an area adjacent to an edge area, while maintaining the characteristic of high frequency components, such as an edge area. Finally, the post-processing unit 490 interpolates an illuminance (Y) component among image data transformed into YCrCb data, such that defects in an area adjacent to an edge area are removed and noise included in the illuminance (Y) signal is removed.

While the present invention has been particularly shown and described with reference to exemplary embodiments thereof, it will be understood by those of ordinary skill in the art that various changes in form and details may be made

What is claimed is:

1. An image signal processing apparatus for removing noise in an image signal, the apparatus comprising;
a GR-GB correction unit to detect a first area in response to a difference between a correction threshold and a value, and filtering noise included in the first area wherein the value comprises an absolute value of a difference between a current pixel of an image signal and neighboring pixels having the same color as that of the current pixel;
a threshold calculation unit to calculate an edge threshold and a similarity threshold in response to a signal level of each pixel of the image signal, and an analog gain control (AGC) value; and
a preprocessing and interpolation unit to compare an edge identifier that is calculated in response to spatial deviation at each pixel of the image signal with the edge threshold, to determine whether the pixel is an edge area or a flat area, and in response to the result of the determination, interpolating each pixel of the image signal to generate an interpolated RGB image signal.

2. The apparatus of claim 1, wherein the GR-GB correction unit filters noise by using sigma filtering.

3. The apparatus of claim 1, wherein the edge threshold is a sum of a corrected level in proportion to the signal level of each of the pixels and an analog gain control (AGC) threshold in proportion to the AGC value.

4. The apparatus of claim 3, wherein the corrected level is calculated from a signal level of a corresponding one of the pixels and one or more image-sensing environment constants.

5. The apparatus of claim 3, wherein the AGC threshold is calculated from the difference between an AGC value of a current frame and a minimum AGC value and one or more image-sensing environment constants.

6. The apparatus of claim 1, wherein the similarity threshold is calculated in proportion to the signal level of each pixel that is currently being processed.

7. The apparatus of claim 1 wherein the preprocessing and interpolation unit comprises:
an edge detection unit to compare the edge identifier calculated in response to the spatial deviation at each pixel of the image signal with the edge threshold to determine whether the pixel is an edge area or a flat area;
a filtering unit, to filter noise included in the flat area by using a predetermined filtering method to generate filtered pixels; and
a first interpolation unit to interpolate the filtered pixels; and
a second interpolation unit interpolating pixels determined to be an edge area by using a predetermined interpolation method.

8. The apparatus of claim 7, wherein the filtering unit filters noise by using sigma filtering.

9. The apparatus of claim 7, wherein the first interpolation unit performs interpolation by using median filtering.

10. The apparatus of claim 7. wherein the second interpolation unit performs interpolation using directional interpolation.

11. The apparatus of claim 1, wherein the image signal is an image signal of a Bayer pattern.

12. The apparatus of claim 11, further comprising:
an image data transform unit to transform the RGB image signal interpolated by the preprocessing and interpolation unit into a YCrCb image signal; and
a post-processing unit interpolating a Y signal in the transformed YCrCb image signal.

13. The apparatus of claim 12, wherein the post-processing unit interpolates the Y signal by using sigma filtering.

14. An image signal processing method for removing noise included in an image signal, the method comprising:
detecting a first area in response to the difference between a correction threshold and a value, and filtering noise included in the first area, wherein the value comprises an absolute value of a difference between a current pixel of an image signal and neighboring pixels having the same color as that of the current pixel;
calculating an edge threshold and a similarity threshold in response to a signal level of each pixel of the image signal, and an analog gain control (AGC) value; and
comparing an edge identifier calculated in response to spatial deviation at each pixel of the image signal with the edge threshold, determining whether the pixel is an edge area or a flat area, and in response to the result of the determination, interpolating each pixel of the image signal to generate an interpolated RGB image signal.

15. The method of claim 14, wherein the calculating of the edge threshold comprises:
calculating a corrected level in proportion to the signal level of each of the pixels;
calculating an AGC threshold in proportion to the AGC value; and adding the corrected level to the AGC threshold.

16. The method of claim 14, wherein the interpolating of each pixel of the image signal comprises:
comparing the edge identifier calculated in response to the spatial deviation at each pixel of the image signal with the edge threshold to determine whether the pixel is an edge area or a flat area;
interpolating pixels determined to be an edge area by using a predetermined interpolation method; and
filtering noise included in the flat area by using a predetermined filtering method to generate filtered pixels and interpolating the filtered pixels.

17. The method of claim 14, wherein the image signal is an image signal of a Bayer pattern.

18. The method of claim 17, further comprising:
transforming the interpolated RGB image signal into a YCrCb image signal; and
interpolating a Y signal in the transformed YCrCb image signal.
